(19) United States
(12) Patent Application Publication
(10) Pub. No.: US 2024/0107637 A1
(43) Pub. Date: Mar. 28, 2024

(54) COOKING APPARATUS

(71) Applicant: SAMSUNG ELECTRONICS CO., LTD., Suwon-si (KR)

(72) Inventors: Sangwon YUN, Suwon-si (KR); Jaegyeong MA, Suwon-si (KR)

(73) Assignee: SAMSUNG ELECTRONICS CO., LTD., Suwon-sI (KR)

(21) Appl. No.: 18/531,180

(22) Filed: Dec. 19, 2023

Related U.S. Application Data
(63) Continuation of application No. PCT/KR2022/008845, filed on Jun. 22, 2022.

(30) Foreign Application Priority Data
Jul. 5, 2021 (KR) 10-2021-0087597
Oct. 6, 2021 (KR) 10-2021-0132669

(51) Int. Cl. H05B 6/64

(52) U.S. Cl. CPC H05B 6/642

(57) ABSTRACT

The present disclosure relates to a cooking apparatus including an outer housing, an inner housing positioned inside the outer housing to provide a cooking chamber, a door provided in front of the inner housing to open and close the cooking chamber, a vent fan positioned in a separation space formed between the outer housing and the inner housing and including a discharge port to flow air through the discharge port, an electrical component located on a route along which air flowing by the vent fan moves, and an electrical component cover including an electrical component cover body provided to surround the electrical component to protect the electrical component from the air flowing by the vent fan.

### TECHNICAL FIELD

The present disclosure relates to a cooking apparatus. More specifically, the present disclosure relates to a cooking apparatus including an electrical component cover for protecting electrical components from external contaminants.

### BACKGROUND ART

Cooking apparatuses are apparatuses for cooking by heating a cooking object such as food, and refer to apparatuses capable of providing various functions related to cooking, such as heating, thawing, drying, and sterilization of a cooking object. Cooking apparatuses include, for example, an oven such as a gas oven and an electric oven, a microwave heating device (hereinafter referred to as a microwave oven), a gas range, an electric range, a hood combined microwave oven (Over the Range; OTR), a gas grill or an electric grill, and the like.

The Over the Range is a microwave oven with a hood function that is responsible for ventilation in a kitchen, in which an installation space is minimized while cooking food more conveniently and efficiently. This Over the Range may be located above a cooking apparatus such as a gas range and a cooktop.

Because the Over the Range among cooking apparatuses functions as a hood, oil vapor generated from a lower side may be introduced into a cooking apparatus. An electrical component positioned on a route along which oil vapor moves may easily break down due to coming into contact with the oil vapor. In particular, there is a risk of fire occurring when the electrical component coming into contact with oil vapor is a connector.

### DISCLOSURE

### Technical Problem

The present disclosure is directed to providing a cooking apparatus capable of protecting electrical components from contaminated air moving inside the cooking apparatus.

The present disclosure is directed to providing a cooking apparatus capable of reducing a possibility of fire occurring when oil vapor flows into the cooking apparatus.

The present disclosure is directed to providing a cooking apparatus in which an electrical component cover for protecting electrical components may be installed in a convenient method.

### Technical Solution

An aspect of the present disclosure provides a cooking apparatus including an outer housing, an inner housing inside the outer housing and including a cooking chamber, a door in front of the inner housing to open and close the cooking chamber, a vent fan including a discharge port and positioned in a separation space between the outer housing and the inner housing, wherein the vent fan is configured to draw air into the cooking apparatus and discharge the air through the discharge port so that the air flows from the discharge port along a route inside the cooking chamber, an electrical component positioned on the route, and an electrical component cover including an electrical component cover body surrounding the electrical component to protect the electrical component from the air flowing along the route.

The electrical component cover body may include a blocking wall between the electrical component and the discharge port of the vent fan to prevent air discharged from the discharge port of the vent fan toward the electrical component from directly coming into contact with the electrical component, and a plurality of walls extending from the blocking wall to cover a periphery of the electrical component, and the plurality of walls may include an upper wall extending upward at a predetermined angle to guide the air flowing by the vent fan.

The cooking apparatus may further include a vent plate between the vent fan and the electrical component to reduce a flow of air to the electrical component and to partition a space in which the electrical component is located and a space in which the vent fan is located.

The electrical component cover may be spaced apart from the discharge port of the vent fan to reduce contact of the air flowing along the route with the electrical component, and the vent plate may include a plate opening positioned to correspond to the discharge port of the vent fan, and a plate guide bent and extending from an edge of the plate opening to guide air discharged from the discharge port of the vent fan.

The vent plate may include a base plate on one side of which the plate opening is formed, and a plate wall bent and extending from an other side of the base plate spaced apart from the plate opening, and the electrical component cover may be coupled to the plate wall to reduce contact of air discharged from the discharge port with the electrical component.

The vent fan may include a first vent fan and a second vent fan positioned at the rear of the first vent fan, the plate opening may include a first plate opening formed to correspond to the first vent fan and a second plate opening formed to correspond to the second vent fan, and the electrical component cover may be between the first plate opening and the second plate opening to reduce direct contact with air discharged from the first vent fan and the second vent fan.

The plate wall may include a plate recess recessed in a direction toward the inner housing at a position where the electrical component is provided.

The plate wall may include a plate fitting protrusion provided by a portion of the plate wall being bent and extending, and the electrical component cover may include, in order to couple the electrical component cover to the plate wall, a cover flange bent and extending from one side of the electrical component cover body facing the plate wall and having an end accommodated in the plate fitting protrusion.

The plate fitting protrusion may include a fitting support part provided by a portion of the plate wall bent and extending, and protruding in a direction in which the electrical component cover is coupled, and a fitting separation prevention part bent from an end of the fitting support part and extending at a determined angle in a direction in which the cover flange is inserted so that the cover flange is smoothly fitted into the plate fitting protrusion.

The plate wall may include a locking opening, and the electrical component cover may include, in order to couple the electrical component cover to the plate wall, a cover protrusion formed at a position corresponding to the locking opening to be accommodated in the locking opening.

The cover protrusion may include a locking support part provided to extend in a direction toward the plate wall to be accommodated in the locking opening, a locking separation prevention part provided to be bent and extend from an end of the locking support part to prevent the cover protrusion from being separated from the locking opening when the cover protrusion is accommodated in the locking opening, and a locking insertion part provided to be bent from an end of the locking separation prevention part and extend toward a base plate to smoothly accommodate a cover locking part in the locking opening.

The plate wall may be positioned adjacent to one side of the inner housing, the plate wall may include a plate cutout piece bent and extending at a predetermined angle in a direction opposite to a direction toward the inner housing, the electrical component cover may include a cover cutout piece at a position corresponding to the plate cutout piece, and the cooking apparatus may further include a coupling member provided to penetrate and be coupled to the plate cutout piece and the cover cutout piece, so that the coupling member is prevented from penetrating the inner housing.

The electrical component cover may include a coupling guide adjacent to a position where the coupling member is to be coupled to guide the coupling of the coupling member and extending beyond a height of the plate cutout piece.

The outer housing may include a circulation air intake port on a lower side of the outer housing to allow air to be introduced into the outer housing, and a circulation air discharge port on an upper side of the outer housing to allow the air introduced from the circulation air intake port to be discharged, the circulation air discharge port may include a first circulation air discharge port adjacent to the vent fan, and a second circulation air discharge port between the first circulation air discharge port and a control panel, the route may include a first circulation flow path along which air discharged from the discharge port of the vent fan is discharged to the first circulation air discharge port, and a second circulation flow path along which air discharged from the discharge port of the vent fan is discharged to the second circulation air discharge port, and the electrical component may be positioned on the first circulation flow path and the electrical component cover may cover the electrical component to reduce contact of air flowing along the first circulation flow path with the electrical component.

The electrical component may be a first electrical component and the electrical component cover may be a first electrical component cover, the cooking apparatus may further include a second electrical component positioned on the second circulation flow path and a second electrical component cover surrounding the second electrical component to reduce contact of air flowing along the second circulation flow path with the second electrical component, the second electrical component cover may include a cover body and a cover hood provided to open and close the cover body, the cover hood may include a hood protrusion provided to protrude toward the cover body when the cover hood comes into contact with the cover body so that separation of the cover hood from the cover body becomes difficult in a state in which the cover hood is in contact with the cover body, and the cover body may include a body protrusion provided to form at a position corresponding to the hood protrusion and protrude toward the cover hood in order to couple the cover hood to the cover body.

Another aspect of the present disclosure provides a cooking apparatus including an outer housing including a circulation air intake port and a circulation air discharge port through which air introduced from the circulation air intake port is discharged, an inner housing provided inside the outer housing to form a separation space between the outer housing and the inner housing, a vent fan positioned in the separation space to flow air introduced into the outer housing from the circulation air intake port, a fan motor connected to the vent fan to drive the vent fan, a first electrical component positioned on a route along which air flowing by the vent fan moves, and a first electrical component cover provided to surround the first electrical component to protect the first electrical component from the air flowing by the vent fan.

The cooking apparatus may further include a vent plate positioned between the vent fan and the first electrical component, the vent plate may include a plate opening positioned on one side of the vent plate to correspond to a discharge port of the vent fan, a plate guide provided to be bent and extend from an edge of the plate opening to guide air discharged from the discharge port of the vent fan, and a plate wall provided to be bent and extend from the other side spaced apart from the plate opening, and the first electrical component cover may be coupled to the plate wall to reduce contact of the air discharged from the discharge port with the first electrical component.

The outer housing may include a circulation air intake port provided on a lower side thereof to allow air to be introduced therein, and a circulation air discharge port provided on an upper side thereof to allow the air introduced from the circulation air intake port to be discharged, the circulation air discharge port may include a first circulation air discharge port positioned adjacent to the vent fan, and a second circulation air discharge port positioned between the first circulation air discharge port and a control panel, the route along which the air flowing by the vent fan moves may include a first circulation flow path along which the air flowed from the vent fan is discharged to the first circulation air discharge port, and a second circulation flow path along which the air flowed from the vent fan is discharged to the second circulation air discharge port, the first electrical component may be positioned on the first circulation flow path and the electrical component cover may cover the first electrical component to reduce contact of air flowing along the first circulation flow path with the first electrical component, the cooking apparatus may further include a second electrical component positioned on the second circulation flow path and a second electrical component cover provided to surround the second electrical component to reduce contact of air flowing along the second circulation flow path with the second electrical component, the second electrical component cover may include a cover body and a cover hood provided to open and close the cover body, the cover hood may include a hood protrusion provided to protrude toward the cover body when the cover hood comes into contact with the cover body so that separation of the cover hood from the cover body becomes difficult in a state in which the cover hood is in contact with the cover body, and the cover body may include a body protrusion provided to form at a position corresponding to the hood protrusion and protrude toward the cover hood in order to couple the cover hood to the cover body.

Another aspect of the present disclosure provides a cooking apparatus capable of being placed above a home appliance that cooks food by heating the food, wherein the cooking apparatus includes an outer housing including a circulation air intake port provided to allow oil vapor generated from the food cooked in the home appliance to be introduced and a circulation air discharge port provided to allow air introduced from the circulation air intake port to be discharged, a connector located on a route along which the oil vapor generated from the food cooked in the home appliance flows, and an electrical component cover provided to surround the connector to protect the connector from the oil vapor generated from the food cooked in the home appliance.

The electrical component cover may include a metal material.

### Advantageous Effects

According to the present disclosure, electrical components can be protected by preventing contact between the electrical components and contaminated air introduced into a cooking apparatus through an electrical component cover peripheries of the electrical components.

According to the present disclosure, a possibility of fire occurring can be reduced by positioning the electrical component cover the peripheries of the electrical components to separate the electrical components from oil vapor introduced into the cooking apparatus.

According to the present disclosure, the electrical component cover installed in the cooking apparatus can be installed in a convenient method by being coupled to the inside of the cooking apparatus using a locking member and a coupling member.

### DESCRIPTION OF DRAWINGS

FIG. 1 is a perspective view of a cooking apparatus according to an embodiment of the present disclosure.

FIG. 2 is a perspective view of the cooking apparatus of FIG. 1, which is viewed from below.

FIG. 3 is a rear exploded perspective view illustrating that an outer housing cover and an outer housing rear plate are separated in the cooking apparatus of FIG. 1.

FIG. 4 is a rear perspective view illustrating that flow paths are indicated in the cooking apparatus of FIG. 3.

FIG. 5 is a side view of the cooking apparatus of FIG. 4, which is viewed from a side.

FIG. 6 is an enlarged perspective view of a part X indicated in the cooking apparatus of FIG. 4.

FIG. 7 is a cross-sectional view taken along a line AA indicated in the cooking apparatus of FIG. 6.

FIG. 8 illustrates that a first electrical component cover is disassembled in the cooking apparatus of FIG. 6.

FIG. 9 is a perspective view of the first electrical component cover illustrated in the cooking apparatus of FIG. 8.

FIG. 10 is a side view of the first electrical component cover of FIG. 9.

FIG. 11 is a front view of the first electrical component cover of FIG. 9.

FIG. 12 is a perspective view of a second electrical component cover illustrated in the cooking apparatus of FIG. 6.

FIG. 13 is a cross-sectional view taken along a line BB′ indicated in the second electrical component cover of FIG. 12.

FIG. 14 is a perspective view illustrating that a cover hood covers a cover body in the second electrical component cover of FIG. 12.

FIG. 15 is a perspective view illustrating that the outer housing cover is removed from the cooking apparatus of FIG. 1.

FIG. 16 is an enlarged perspective view of a power connector in a part Y indicated in the cooking apparatus of FIG. 15.

FIG. 17 is a top view of the power connector of FIG. 16, which is viewed from above.

### MODE OF THE DISCLOSURE

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, components, parts, or combinations thereof described in the specification, and do not exclude the presence or addition of one or more other features, numbers, steps, operations, components, parts, or combinations thereof.

It will be understood that, although the terms first, second, etc. may be used herein to describe various components, these components should not be limited by these terms, the terms are only used to distinguish one component from another. For example, without departing from the scope of the present disclosure, a first component may be referred to as a second component, and similarly, the second component may also be referred to as a first component. The term “and/or” includes any combination of a plurality of related items or any one of a plurality of related items.

In this specification, the terms “up-down direction,” “lower portion,” “front-rear direction,” and the like used in the following description are defined with reference to the drawings, and the shape and position of each component are not limited by these terms.

Hereinafter, embodiments of the present disclosure will be described in detail with reference to the accompanying drawings.

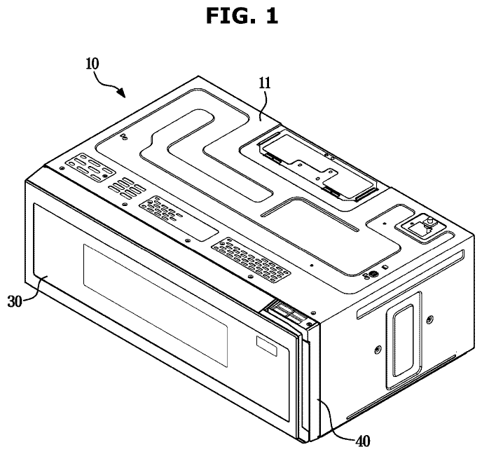

FIG. 1 is a perspective view of a cooking apparatus 1 according to an embodiment of the present disclosure.

As illustrated in FIG. 1, the cooking apparatus 1 may include an outer housing 10 forming an exterior and a door 30 coupled to the front of the outer housing 10.

The cooking apparatus 1 may include a control panel 40 coupled to the front of the outer housing 10. The front of the control panel 40 may be covered by the door 30. More specifically, the control panel 40 may be coupled to the outer housing 10 to be disposed between the door 30 and the outer housing 10.

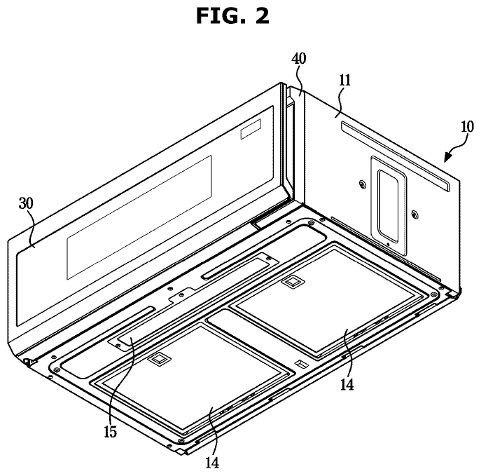

FIG. 2 is a perspective view of the cooking apparatus 1 of FIG. 1, which is viewed from below.

As illustrated in FIG. 2, the outer housing 10 of the cooking apparatus 1 may include an outer housing cover 11 including an upper surface and opposite side surfaces of the outer housing 10, and a housing plate 13 forming a lower surface of the outer housing 10. The housing plate 13 may be formed separately from the outer housing cover 11, but may also be formed integrally with the outer housing cover 11.

The housing plate 13 may include a circulation air intake port 14 for intake of outside air.

For convenience of explanation, the present disclosure illustrates that a separate home appliance is provided below a microwave oven and the microwave oven has a hood function for discharging contaminated air generated from food cooked in the home appliance to the outside. However, the present disclosure is not limited thereto and may be applied to any cooking apparatus.

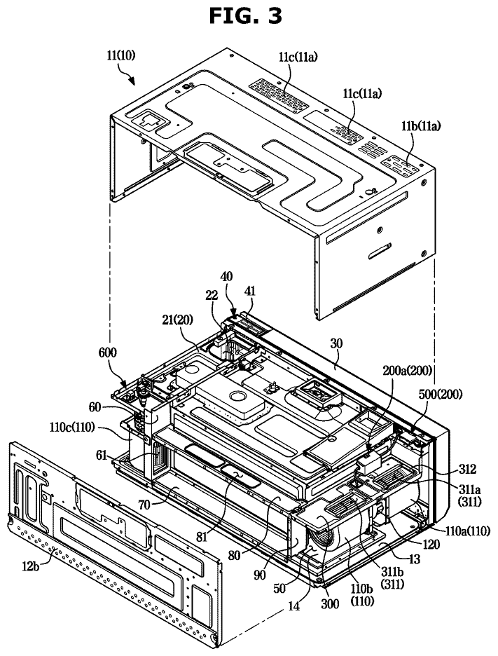

Food may be cooked separately below the cooking apparatus 1 of the present disclosure, and oil vapor may be generated when food is cooked below the cooking apparatus 1. In this case, because the cooking apparatus 1 of the present disclosure may perform the hood function, in order to discharge oil vapor generated by cooking food to the outside, the cooking apparatus 1 may intake the oil vapor into the inside thereof. At this time, when a vent fan 110 (FIG. 3) positioned inside the outer housing 10 operates, the oil vapor generated from food may be drawn into the outer housing 10 through the circulation air intake port 14.

Because food may be cooked below the cooking apparatus 1, the circulation air intake port 14 may be provided on the housing plate 13 which may be disposed at a lower side of the cooking apparatus 1 which may be positioned above the food.

The drawn oil vapor may flow inside the outer housing 10 and then be discharged to the outside of the cooking apparatus 1 through a circulation air discharge port 11a.

The housing plate 13 may include a lighting unit 15. The lighting unit 15 may be disposed in front of the circulation air intake port 14. The lighting unit 15 may be disposed to emit light below the cooking apparatus 1 when a cooktop, etc. is installed below the cooking apparatus 1.

FIG. 3 is a rear exploded perspective view illustrating that the outer housing cover 11 and an outer housing rear plate 12b are separated in the cooking apparatus 1 of FIG. 1.

As illustrated in FIG. 3, the outer housing 10 may have the upper surface and opposite side surfaces integrally formed to form the outer housing cover 11. Because the outer housing cover 11 may be formed integrally, an assembly time may be shortened compared to a structure in which respective surfaces are formed of individual plates.

The housing may include the outer housing 10 and an inner housing 20.

The outer housing cover 11 may include the circulation air discharge port 11a formed on an upper surface thereof. Because the housing plate 13 positioned on a lower side of the outer housing 10 may include the circulation air intake port 14, the air introduced into the cooking apparatus 1 through the circulation air intake port 14 is discharged to the outside through the circulation air discharge port 11a positioned on the upper surface of the outer housing 10.

Inside the outer housing 10, the inner housing 20 may be disposed to form a cooking chamber (not shown). A separation space 50 may be provided between the outer housing 10 and the inner housing 20.

An electrical component room (not shown) in which electrical components 100 are disposed may be provided in the separation space 50 formed between the outer housing 10 and the inner housing 20. Various types of the electrical components 100 for operating cooking apparatus 1 may be disposed in the electrical component room (not shown). The electrical components 100 may include a magnetron, a sensor, the vent fan 110, a connector 130, a conducting wire 140, and the like. The vent fan 110 may be positioned in the separation space 50 in addition to the electrical component room (not shown).

The vent fan 110 may be positioned in the separation space 50 provided between the outer housing 10 and the inner housing 20. The vent fan 110 may be positioned above the circulation air intake port 14. The vent fan 110 positioned above the circulation air intake port 14 may draw air into the cooking apparatus 1 through the circulation air intake port 14.

The circulation air discharge port 11a formed on the outer housing cover 11 may include a first circulation air discharge port 11b positioned adjacent to the vent fan 110. The first circulation air discharge port 11b may be positioned at the front. The circulation air discharge port 11a may include a second circulation air discharge port 11c positioned between the first circulation air discharge port 11b and the control panel 40. The second circulation air discharge port 11c may be positioned adjacent to the front of an inner housing upper plate 21.

On an upper side of the control panel 40, a cooling air inlet 41 may be provided through which air is introduced to cool the electrical components 100 in the electrical component room (not shown). The air introduced through the cooling air inlet 41 may cool the electrical components 100 in the electrical component room (not shown).

Because the control panel 40 and the circulation air discharge port 11a may be spaced apart from each other, the air discharged from the circulation air discharge port 11a may be prevented from being introduced into the cooling air inlet 41. Because the air discharged from the circulation air discharge port 11a may be high-temperature air containing oil vapor generated from food cooked in the home appliance located below cooking apparatus 1, when such air is introduced through the cooling air discharge port, the electrical components 100 in the electrical component room (not shown) may break down. However, because the circulation air discharge port 11a is spaced apart from the cooling air inlet 41, warm air mixed with oil vapor may be prevented from being introduced into the electrical component room (not shown).

In order to drive the vent fan 110, a fan motor 120 coupled to the vent fan 110 may be provided adjacent to the vent fan 110.

The electrical component room may be positioned on one side of the separation space 50 formed between the outer housing 10 and the inner housing 20, and the vent fan 110 may be positioned on the other side thereof. Through this, a flow for cooling the electrical component room and a flow for discharging contaminated air generated from the home appliance located below the cooking apparatus 1 through the vent fan 110 may be separated.

The electrical components 100 may be positioned above the vent fan 110. For example, the connector 130 may be positioned above the vent fan 110 in order to increase a length of an electric wire for connecting a power source of the vent fan 110. Because the vent fan 110 is used in various devices and producing the respective different vent fans 110 for the various devices lowers production efficiency, a model of the vent fan 110 may be preset. When the length of the electric wire connecting the power source to the set vent fan 110 model is short, the length of the electric wire may be increased by connecting another electric wire using the connector 130. In this case, because the model of the vent fan 110 is preset, positions where the connector 130 may be located may be limited. When the connector 130 needs to be positioned adjacent to the vent fan 110, the connector 130 may be positioned on a flow path through which air introduced from the circulation air intake port 14 passes.

A home appliance capable of cooking food may be located below the cooking apparatus 1, and when the home appliance cooks food, contaminated air is introduced into the cooking apparatus 1 through the circulation air intake port 14. The introduced air may direct to the electrical components 100 positioned above the vent fan 110.

The contaminated air may contain high-temperature oil vapor. When the contaminated air containing oil vapor comes into contact with the electrical component 100, oil contained in the contaminated air may adhere to the electrical component 100. Accordingly, the electrical component 100 may break down.

In addition, in a case in which the electrical component 100 is the connector 130, because the connector 130 is connected to an electric wire, a fire may occur in a corresponding part.

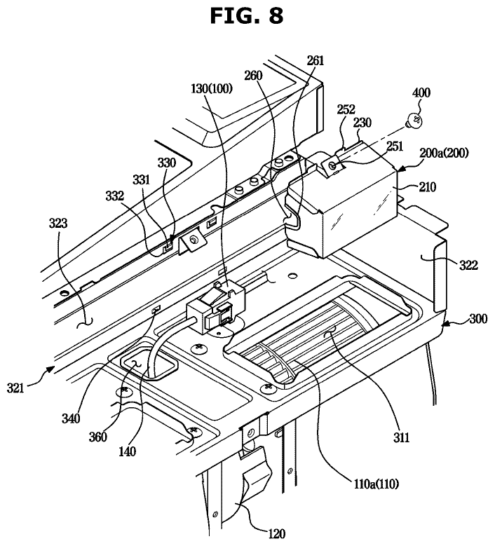

In order to solve this problem, the cooking apparatus 1 may include an electrical component cover 200 provided to surround the electrical component 100 located on a route along which air flowing by the vent fan 110 moves. The electrical component cover 200 may include an electrical component cover body 210 (FIG. 8) provided to surround the electrical component 100 to protect the electrical component 100 from air flowing by the vent fan 110.

The vent fan 110 may include a discharge port 111 through which air drawn from the circulation air intake port 14 is discharged. The discharge port 111 may be positioned to be spaced apart from the electrical component 100 located on the route along which the air flowing by the vent fan 110 moves. Accordingly, direct contact of contaminated air with the electrical component 100 may be reduced. In other words, the electrical component 100 may have a low possibility of breaking down.

Because the electrical component cover 200 may be provided to surround the electrical component 100, the discharge port 111 of the vent fan 110 and the electrical component cover 200 may be positioned to be spaced apart from each other.

The vent fan 110 may include a first vent fan 110a provided at a position adjacent to the door 30. The vent fan 110 may include a second vent fan 110b positioned adjacent to the first vent fan 110a at the rear of the first vent fan 110a.

A vent plate 300 may be positioned above the vent fan 110. In other words, the vent fan 110 may be positioned on one side of the vent plate 300. The electrical component 100 may be positioned on the other side of the vent plate 300. The vent plate 300 may partition the electrical component 100 and the vent fan 110, thereby reducing contact of contaminated air flowing by the vent fan 110 with the electrical component 100.

The vent plate 300 may include a plate opening 311 provided at a position corresponding to the discharge port 111 of the vent fan 110. The vent plate 300 may include a plate guide 312 protruding from an inner circumference of the plate opening 311 in a direction in which air discharged from the discharge port 111 of the vent fan 110 flows. Accordingly, the air discharged from the vent fan 110 may be guided to flow further in the discharge direction toward the circulation air discharge port 11a. Because the electrical component 100 may be positioned to be spaced apart from the discharge port 111 of the vent fan 110, when air is guided by the plate guide 312, it may be difficult to direct the contaminated air directly toward the electrical component 100.

The plate guide 312 may have a shape of being bent and extending from the inner circumference of the plate opening 311. By this shape, the plate guide 312 may be produced together with the plate opening 311 without going through a process of making and attaching a separate plate guide, so that a production time of the cooking apparatus 1 may be shortened.

The plate opening 311 formed on the vent plate 300 may include a first plate opening 311a provided at a position corresponding to the discharge port 111 of the first vent fan 110a. The plate opening 311 may include a second plate opening 311b provided at a position corresponding to the discharge port 111 of the second vent fan 110b.

The electrical component cover 200 may be coupled to the vent plate 300 between the first plate opening 311a and the second plate opening 311b so that the electrical component 100 is positioned between the first plate opening 311a and the second plate opening 311b. Accordingly, the direct contact of contaminated air with the electrical component 100 may be reduced.

When the conducting wire 140 connected to the electrical component 100 protected by the electrical component cover 200 is connected to the electrical component 100 at the rear, in order to prevent the conducting wire 140 from being twisted, the electrical component cover 200 may be positioned relatively toward the first plate opening 311a, which is positioned further forward than the second plate opening 311b.

When the electrical component cover 200 for protecting the electrical component 100 positioned above the vent fan 110 is referred to as a first electrical component cover 200a, the cooking apparatus 1 may further include a second electrical component cover 500 to protect the electrical component 100 positioned on the door 30 side.

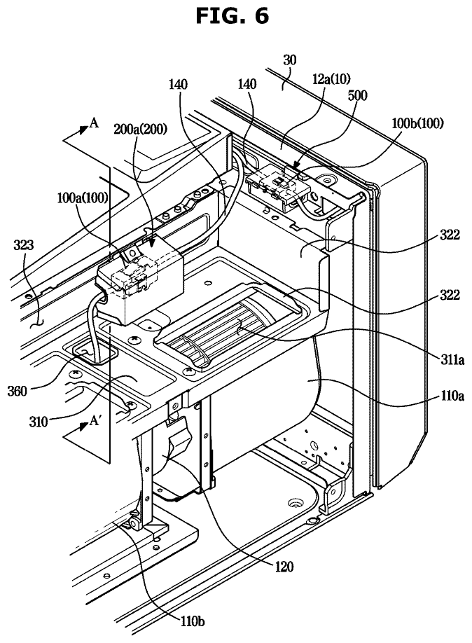

The electrical component 100 protected by the first electrical component cover 200a may be referred to as a first electrical component 100a (FIG. 6). The electrical component 100 protected by the second electrical component cover 500 may be referred to as a second electrical component 100b (FIG. 6).

The electrical component 100 protected by the first electrical component cover 200a may be the connector 130. The electrical component 100 protected by the second electrical component cover 500 may be the conducting wire 140.

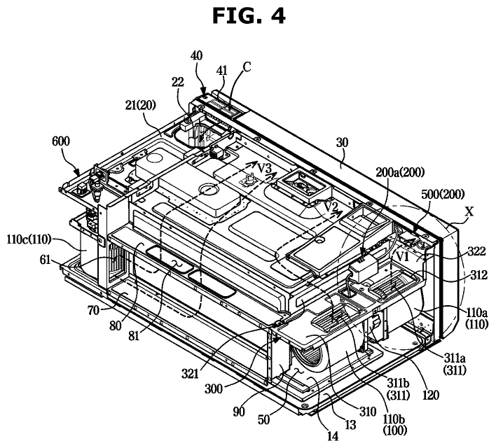

Descriptions of other configurations illustrated in the drawing will be given later with reference to FIG. 4 in which flow paths are indicated.

FIG. 4 is a rear perspective view illustrating that flow paths are indicated in the cooking apparatus 1 of FIG. 3.

As illustrated in FIG. 4, air outside the cooking apparatus 1 may be introduced into the cooking apparatus 1 through the cooling air inlet 41 positioned on the upper side of the control panel 40.

The air introduced through the cooling air inlet 41 may be introduced into the electrical component room (not shown) through a cutout portion 22 provided on the upper plate of the inner housing 20.

The air introduced into the electrical component room (not shown) may cool the electrical component 100 in the electrical component room (not shown), move inside the inner housing 20, and be discharged to the outside of the cooking apparatus 1 through an outlet (not shown) provided on the door 30 side.

This may be referred to as a cooling flow path C.

Air may be drawn from below the cooking apparatus 1 through the circulation air intake port 14 of the housing plate 13 positioned on the lower surface of the outer housing 10. The drawn air may be contaminated air.

The vent fan 110 may include the first vent fan 110a and the second vent fan 110b positioned on one side of the separation space 50, and may include a third vent fan 110c positioned on the other side of the separation space 50 to be spaced apart from the first vent fan 110a and the second vent fan 110b. The third vent fan 110c may flow air drawn through the circulation air intake port 14 to the rear of the inner housing 20.

When air is flowed from the third vent fan 110c to the rear of the inner housing 20, the air may be flowed to the rear of the inner housing 20 through a communication portion 61 of a rear bracket 60 positioned adjacent to the discharge port 111 side of the third vent fan 110c.

The cooking apparatus 1 may include a bottom bracket 70, a partition bracket 80, and a circulation divider 90.

The bottom bracket 70 and the partition bracket 80 may be disposed between the outer housing 10 and the inner housing 20. More specifically, the bottom bracket and partition bracket 80 may be disposed at the rear of the inner housing 20 to extend horizontally. The bottom bracket 70 may be disposed below the partition bracket 80 to face the partition bracket 80.

The circulation divider 90 may be disposed between the outer housing 10 and the inner housing 20. More specifically, the circulation divider 90 may be disposed at the rear of the inner housing 20 to extend horizontally. That is, the circulation divider 90 may be disposed to face the communication portion 61 of the rear bracket 60.

The partition bracket 80 may include a communication hole 81. The communication hole 81 may be formed by cutting a portion of the partition bracket 80. The communication hole 81 may be provided to allow air to flow.

Accordingly, the rear bracket 60, the bottom bracket 70, the partition bracket 80, and the circulation divider 90 may form a portion of the flow path through which air introduced into the circulation air intake port 14 flows.

The air introduced into the circulation air intake port 14 may pass through the third vent fan 110c, pass through the communication portion 61 of the rear bracket 60, and flow between the bottom bracket 70 and the partition bracket 80.

In this case, the circulation divider 90 may be closed without an open portion and disposed between the partition bracket 80 and the bottom bracket 70. Accordingly, the flowed air may flow to a rear upper portion of the inner housing 20 through the communication hole 81 of the partition bracket 80.

The air flowed to the upper portion of the inner housing 20 through the communication hole 81 may be discharged to the outside of the cooking apparatus 1 through the first circulation air discharge port 11b and the second circulation air discharge port 11c which are formed on a front upper side of the outer housing 10. This may be referred to as a third circulation flow path V3.

As the circulation divider 90 is provided to be closed, the air introduced by the third vent fan 110c and the air introduced by the first vent fan 110a and the second vent fan 110b may flow in a separated state at a lower portion of the inner housing 20 and join together at the upper portion thereof.

The air introduced into the circulation air intake port 14 may pass through the vent fan 110 and then pass through the plate opening 311 of the vent plate 300. The air passed through the plate opening 311 may be discharged to the outside of cooking apparatus 1 through the second circulation air discharge port 11a of the outer housing 10. This may be referred to as a second circulation flow path V2.

The air introduced into the circulation air intake port 14 may pass through the vent fan 110, pass through the plate opening 311 of the vent plate 300, and be discharged to the outside of the cooking apparatus 1 through the first circulation air discharge port 11b of the outer housing 10. This may be referred to as a first circulation flow path V1.

FIG. 4 illustrates that the second circulation flow path V2 is a flow path through which the air passed through the second vent fan 110b and the second plate opening 311b passes through the second circulation air discharge port 11c. In addition, the drawing illustrates that the first circulation flow path V1 is a flow path through which the air passed through the first vent fan 110a and the opening of the first vent plate 300 passes through the first circulation air discharge port 11b. However, this is only one example, and the flow path passed through the second vent fan 110b may also form the first circulation flow path V1 and the flow path passed through the first vent fan 110a may also form the second circulation flow path V2.

The vent plate 300 may include a base plate 310 provided to face in a direction toward the vent fan 110. Accordingly, the plate opening 311 may be seen as being positioned on one side of the base plate 310.

The vent plate 300 may include a plate wall 320 bent and extending from the other side of the base plate 310 spaced apart from the plate opening 311.

The electrical component cover 200 may be coupled to the plate wall 320. Because the plate wall 320 is positioned to be spaced apart from the plate opening 311, the electrical component 100 surrounded by the electrical component cover 200 coupled to the plate wall 320 may be provided to make it difficult for air discharged from the plate opening 311 to directly come into contact with the electrical component 100.

The plate wall 320 may include a first plate wall 321 facing the inner housing 20. The plate wall 320 may include a second plate wall 322 positioned adjacent to the first plate wall 321 and facing the door 30.

The first electrical component cover 200a may be positioned to be coupled to the first plate wall 321.

Because the second circulation flow path V2 is a flow path leading from the vent fan 110 positioned on one side of the inner housing 20 to the second circulation air outlet 110c positioned on an upper side of the outer housing 10, the second circulation flow path V2 may form a flow path passing through one side surface of the inner housing 20. Because the first electrical component cover 200a is coupled to the first plate wall 321 positioned on the one side surface of the inner housing 20, the first electrical component cover 200a may mainly serve to protect the electrical component 100 from contaminated air passing through the second circulation flow path V2.

The second electrical component cover 500 may be positioned adjacent to the second plate wall 322.

Because the first circulation flow path V1 is a flow path leading from the plate opening 311 to the first circulation air discharge port 11b, the first circulation flow path V1 may form a flow path passing through the door 30 side. Because the second electrical component cover 500 is coupled to the second plate wall 322 positioned on the door 30 side, the second electrical component cover 500 may mainly serve to protect the electrical component 100 from contaminated air passing through the first circulation flow path V1.

The first electrical component cover 200a may have the connector 130 located therein, and because a moving distance of oil vapor to the electrical component cover 200 through the second circulation flow path V2 is shorter than a moving distance of oil vapor to the electrical component cover 200 through the first circulation flow path V1, contaminated air flowing on the second circulation flow path V2 has a high temperature and a high possibility of containing a large amount of oil vapor. Therefore, there is a high possibility of fire occurring in the electrical component 100 inside the first electrical component cover 200a. In order to prevent a fire from spreading when the fire occurs, the first electrical component cover 200a may include a metal material.

Because the conducting wire 140 may be located within the second electrical component cover 500, the possibility of fire occurring is low. Therefore, in order to reduce a cost, the second electrical component cover 500 may include a plastic material.

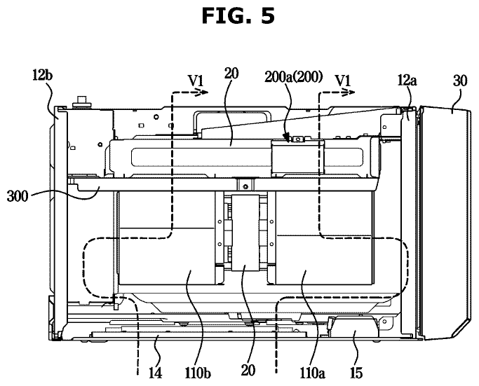

FIG. 5 is a side view of the cooking apparatus 1 of FIG. 4, which is viewed from a side.

As illustrated in FIG. 5, the first circulation flow path V1 may be formed of air introduced through the circulation air intake port 14 positioned on the lower side of the outer housing 10. The air passed through the circulation air intake port 14 may pass through the vent fan 110 and move onto the vent plate 300 through the plate opening 311, and the moved air may be discharged through the circulation air discharge port 11a provided on the front upper side of the outer housing 10.

FIG. 6 is an enlarged perspective view of a part X indicated in the cooking apparatus 1 of FIG. 4.

As illustrated in FIG. 6, the vent plate 300 may include a connector hole 360 formed on the base plate 310 through which the conducting wire 140 connected to the vent fan 110 passes. The connector hole 360 may be provided between the first plate opening 311a and the second plate opening 311b. Accordingly, contact of contaminated air passing through the plate opening 311 with the conducting wire 140 passing through the connector hole 360 may be reduced.

The plate wall 320 may include a plate recess 323 provided to be recessed in a direction toward the inner housing 20 at a position where the electrical component 100 is provided. More specifically, the first plate wall 321 may include the plate recess 323. To be recessed in the direction toward the inner housing 20 from the first plate wall 321 may mean to move away from a direction toward the plate opening 311. Accordingly, the contaminated air passing through the plate opening 311 moves away from the electrical component 100 that the first electrical component cover 200a is to protect, so that the contact of the contaminated air with the electrical component 100 may be reduced.

The second electrical component cover 500 may be provided to protect the electrical component 100 positioned on the door 30 side. In other words, the second electrical component cover 500 may be positioned adjacent to the outer housing front plate 12a, which is the outer housing 10 positioned on the door 30 side.

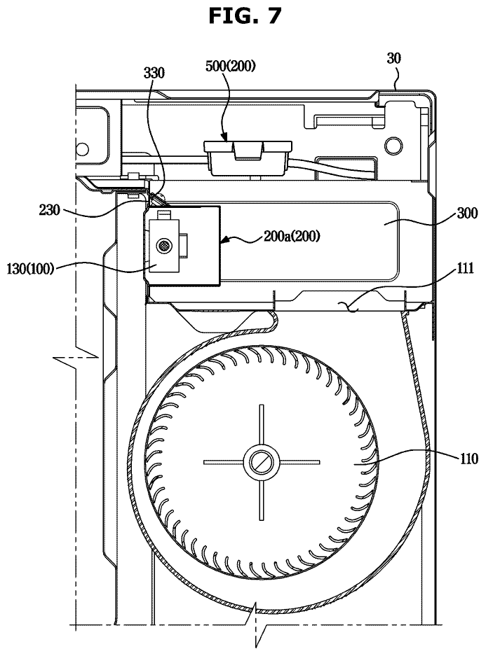

FIG. 7 is a cross-sectional view taken along a line AA indicated in the cooking apparatus 1 of FIG. 6.

As illustrated in FIG. 7, the first electrical component cover 200a may include a cover cutout piece 250 extending from the electrical component cover body 210 at a predetermined angle.

The first plate wall 321 may include a plate cutout piece 350 provided in a shape corresponding to the cover cutout piece 250 of the first electrical component cover 200a.

The cooking apparatus 1 may include a coupling member 400 provided to penetrate the cover cutout piece 250 and the plate cutout piece 350 to couple the first electrical component cover 200a to the first plate wall 321.

Because the cover cutout piece 250 may extend at the predetermined angle in a direction of being spaced apart from the inner housing 20, when the coupling member 400 penetrates the cover cutout piece 250 and the plate cutout piece 350, the coupling member 400 may be prevented from penetrating the inner housing 20.

The first plate wall 321 may include a plate fitting protrusion 330 provided by a portion of the first plate wall 321 being bent and extending. More specifically, the plate fitting protrusion 330 may extend downward.

The first electrical component cover 200a may include a cover flange 230 provided to be bent and extend from one side of the electrical component cover body 210 facing the plate wall 320 and to have an end accommodated in the plate fitting protrusion 330. More specifically, the cover flange 230 may extend upward from the electrical component cover body 210.

Because the cover flange 230 is fitted into the plate fitting protrusion 30 to fix the first electrical component cover 200a to the first plate wall 321, the electrical component cover 200 may be coupled to the plate wall 320 without fastening the additional coupling member 400. Because when the coupling member 400 is used, a process of fastening the coupling member 400 is added when the cooking apparatus 1 is produced, in order to shorten a process time, the number of the coupling members 400 to be fastened needs to be reduced. Because the electrical component cover 200 is fixed by fitting the cover flange 230 into the plate fitting protrusion 330, the production time of the cooking apparatus 1 may be shortened by the cover flange 230 and the plate insertion protrusion 330.

In addition, the coupling member 400 penetrating the cover cutout piece 250 and the plate cutout piece 350 may be stably coupled.

FIG. 8 illustrates that the first electrical component cover 200a is disassembled in the cooking apparatus 1 of FIG. 6.

As illustrated in FIG. 8, the cover cutout piece 250 may include a cover cutout piece hole 251. The plate cutout piece 350 may include a plate cutout piece hole 351. The coupling member 400 may penetrate the cover cutout piece hole 251 and the plate cutout piece hole 351 to couple the body of the first electrical component cover 200a to the first plate wall 321.

The first electrical component cover 200a may include a coupling guide 252 provided adjacent to a position where the coupling member 400 is to be coupled to guide the coupling of the coupling member 400 and extending beyond a height of the plate cutout piece 350.

The coupling guide 252 may be provided to extend upward from the cover flange 230. The coupling guides 252 may be positioned on opposite sides of the cover cutout piece 250, respectively. When the cover cutout piece hole 251 is matched to the plate cutout piece hole 351 in order to couple the first electrical component cover 200a to the first plate wall 321, the coupling guides 252 come into contact with the opposite sides of the plate cutout piece 350, an exact position may be easily found.

The plate fitting protrusion 330 may include a fitting support part 331 provided by a portion of the first plate wall 321 being bent and extending, and protruding in a direction in which the electrical component cover 200 is coupled. More specifically, the fitting support part 331 may extend in a direction opposite to the direction toward the inner housing 20.

The plate fitting protrusion 330 may include a fitting separation prevention part 332 provided to be bent from an end of the fitting support part 331 and extend at a determined angle in a direction in which the cover flange 230 is inserted. More specifically, the fitting separation prevention part 332 may extend in a direction toward the base plate 310.

The fitting separation prevention part 332 may extend at a determined angle in a direction away from the first plate wall 321. Therefore, the cover flange 230 may be smoothly accommodated when inserted into the fitting separation prevention part 332 side.

The first plate wall 321 may include a locking opening 340.

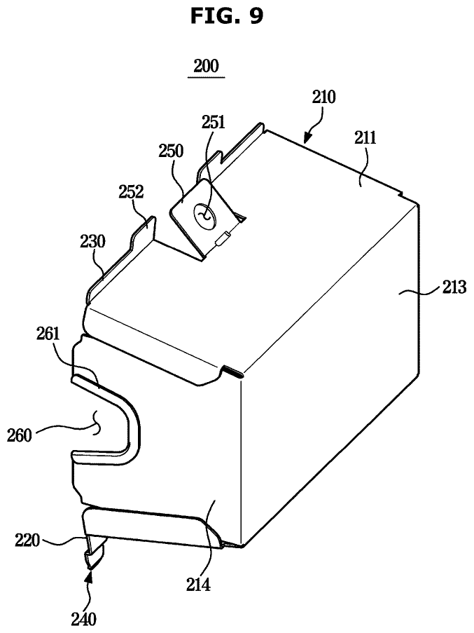

The first electrical component cover 200a may include a cover protrusion 240 (FIG. 9) formed at a position corresponding to the locking opening 340 to be accommodated in the locking opening 340.

Because the first electrical component cover 200a is fixed to the first plate wall 321 as the cover protrusion 240 (FIG. 9) is caught on the locking opening 340, the use of the additional coupling member 400 is not required, so that the production time of the cooking apparatus 1 may be shortened. In addition, the coupling member 400 may be stably fastened. A detailed description of this will be given later with reference to FIG. 9.

The first electrical component cover 200a may include a first electrical component hole 260 provided on a side surface thereof so that the conducting wire 140 may pass therethrough. Compared to a case in which the entire side surface of the first electrical component cover 200a is open, less contaminated air may be introduced into the electrical component 100 in a case in which the first electrical component hole 260 is provided.

The first electrical component hole 260 may include a first hole protrusion 261 protruding from an inner circumference thereof in a side surface direction of the electrical component cover 200. The first hole protrusion 261 may be provided by being bent from the inner circumference of the hole of the first electrical component cover 200a. Accordingly, damage to the conducting wire 140 passing through the first electrical component hole 260 may be prevented.

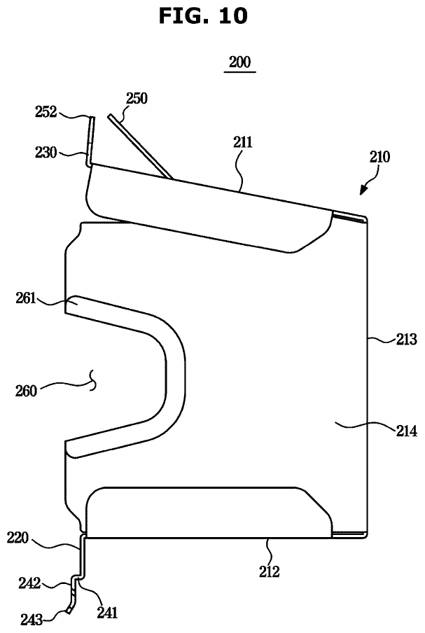

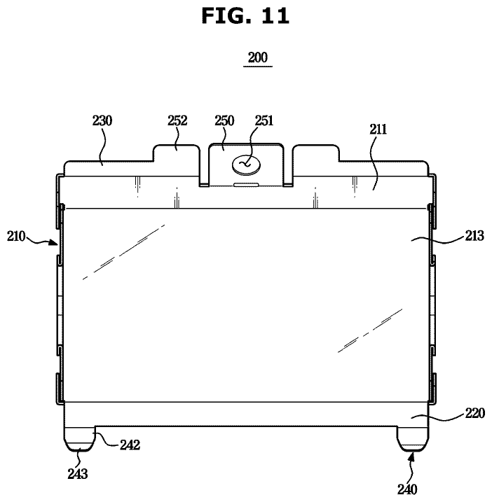

FIG. 9 is a perspective view of the first electrical component cover 200a illustrated in the cooking apparatus 1 of FIG. 8. FIG. 10 is a side view of the first electrical component cover 200a of FIG. 9. FIG. 11 is a front view of the first electrical component cover 200a of FIG. 9.

As illustrated in FIGS. 9, 10 and 11, the electrical component cover 200 may include an electrical component cover body 210 forming a body.

The electrical component cover body 210 may include a blocking wall 213 positioned between the electrical component 100 located on the inside and the discharge port 111 of the vent fan 110. The blocking wall 213 may prevent direct contact of contaminated air flowing through the circulation flow paths V1, V2, and V3 with the electrical component 100. In other words, the blocking wall 213 may prevent air discharged from the discharge port 111 of the vent fan 110 toward the electrical component 100 from directly coming into contact with the electrical component 100.

The electrical component cover body 210 may include a plurality of walls 211, 212, and 214 extending from the blocking wall 213 to cover a periphery of the electrical component. The plurality of walls 211, 212, and 214 may include the upper wall 211 provided on an upper side, the lower wall 212 provided on a lower side, and the opposite side walls 214 provided on left and right sides.

The upper wall 211 of the electrical component cover body 210 may be formed to be inclined at a predetermined angle. Considering that the second circulation flow path V2 may be formed along the side surface of the inner housing 20, when air moves along the second circulation flow path V2, the air may move smoothly along an inclined upper surface of the electrical component cover body 210. In other words, the upper wall 211 may extend upward at a determined angle to guide air flowing by the vent fan 110.

The first electrical component cover 200a may include the cover flange 230 provided to be bent from an end of the upper wall 211 of the electrical component cover body 210 and extend upward. The cover flange 230 may be formed integrally with the upper wall 211 of the electrical component cover body 210.

The coupling guide 252 may be positioned adjacent to the cover cutout piece 250 and formed to extend upward from the cover flange 230.

The first electrical component cover 200a may include a locking flange 220 provided to be bent from an end of the lower wall 212 of the electrical component cover body 210 and extend downward. The locking flange 220 may be formed integrally with the lower wall 212 of the electrical component cover body 210.

The first electrical component cover 200a may include the cover protrusion 240 protruding downward from an end of the locking flange 220. The cover protrusion 240 may be accommodated in the locking opening 340 formed on the first plate wall 321 to fix the first electrical component cover 200a. The cover protrusion 240 may be formed integrally with the locking flange 220.

The cover protrusions 240 may be provided on opposite sides of the locking flange 220, respectively. The locking openings 340 may be formed on the first plate wall 321 to correspond to the positions where the cover protrusions 240 are provided, respectively. Accordingly, the first electrical component cover 200a may be prevented from shaking in left and right directions.

The cover protrusion 240 may include a locking support part 241 provided to extend in a direction toward the first plate wall 321 to be accommodated in the locking opening 340.

The cover protrusion 240 may include a locking separation prevention part 242 provided to be bent and extend from an end of the locking support part 241 to prevent the cover protrusion 240 from being separated from the locking opening 340 when the cover protrusion 240 is accommodated in the locking opening 340.

The cover protrusion 240 may include a locking insertion part 243 provided to be bent from an end of the locking separation prevention part 242 at a predetermined angle and extend toward the base plate 310 to smoothly accommodate a cover locking part in the locking opening 340.

The locking insertion part 243 may be bent at a predetermined angle toward the first plate wall 321. Accordingly, the cover locking part may be easily accommodated in the locking opening 340.

The first electrical component hole 260 and the first hole protrusion 261 through which the conducting wire passes may be positioned on the opposite side walls 214 of the electrical component cover body 210.

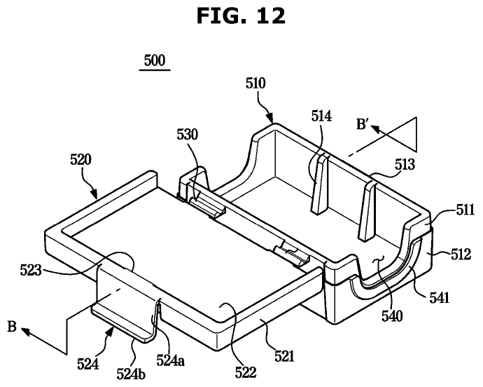

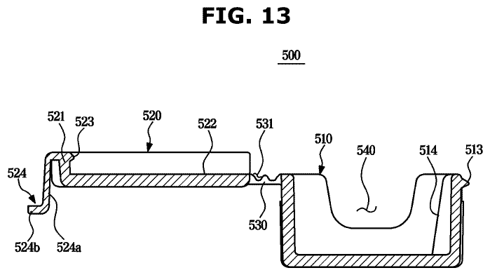

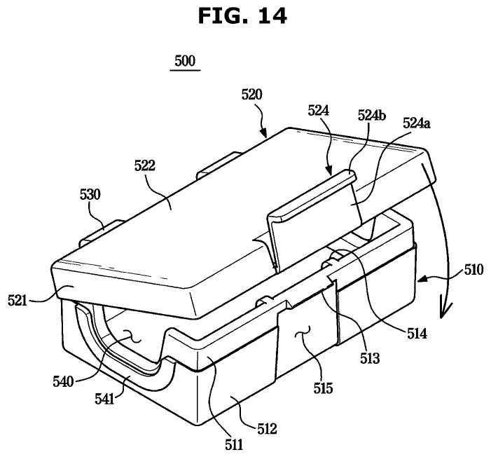

FIG. 12 is a perspective view of the second electrical component cover 500 illustrated in the cooking apparatus 1 of FIG. 6. FIG. 13 is a cross-sectional view taken along a line BB′ indicated in the second electrical component cover 500 of FIG. 12. FIG. 14 is a perspective view illustrating that a cover hood 520 covers a cover body 510 in the second electrical component cover 500 of FIG. 12.

As illustrated in FIGS. 12, 13 and 14, the second electrical component cover 500 may include the cover body 510 forming a main body and the cover hood 520 capable of covering the cover body 510.

A hood hinge 530 may be provided between the cover hood 520 and the cover body 510. The cover hood 520 may be coupled to one side of the hood hinge 530, and the cover body 510 may be coupled to the other side thereof. The hood hinge 530 may be made of a flexible material.

The hood hinge 530 may have a hinge groove 531 formed therein. The hood hinge 530 may be folded by the hinge groove 531 in a direction perpendicular to a direction in which the hinge groove extends. Accordingly, the cover hood 520 coupled with the hood hinge 530 may be opened and closed.

The cover hood 520 may include a hood plate 522 and a hood contact part 521 protruding from the hood plate 522. The hood contact part 521 may open and close an upper side of the cover body 510 while coming into contact with the body contact part 511 provided on the cover body.

The cover body 510 may include a body support part 512 on a lower side of the body contact part 511. Because the body support part 512 protrudes further outward than the body contact part 511, the cover hood 520 may cover the upper side of the cover body 510 only until the cover hood 520 comes into contact with the body contact part 511. Accordingly, an angle at which the cover hood 520 may move may be limited.

The cover hood 520 may include a hood handle 524 provided on the opposite side of one side coupled to the cover body 510. A user may hold the hood handle 524 to open and close the cover hood 520.

The hood handle 524 may include a hood handle extension part 524a provided to be bent from the hood contact part 521 and extend toward an upper side of the hood plate 522.

The hood handle 524 may include a hood handle hold part 524b provided to extend from an end of the hood handle extension part 524a toward the front of the hood plate 522. Because the hold part protrudes outside the second electrical component cover 500 even when the cover hood 520 closes the upper side of the cover body 510, the user may easily hold the hood handle 524.

The cover hood 520 may include a hood protrusion 523 provided to protrude from the hood contact part 521 toward the inside of the cover hood 520. The cover body 510 may include a body protrusion 513 provided to protrude from the body contact part 511 toward the outside of the cover body 510. Through this, when the cover hood 520 comes into contact with the cover body 510 and completely closes the upper side of the cover body 510, separation of the cover hood 520 from the cover body 510 may become difficult.

More specifically, when the cover hood 520 closes the upper side of the cover body 510, the hood protrusion 523 is positioned below the body protrusion 513, so that separation of the cover hood 520 from the cover body 510 may become difficult.

The cover hood 520 includes the hood protrusion 523 provided to protrude toward the cover body 510 when the cover hood 520 comes into contact with the cover body 510, and the cover body 510 may include the body protrusion 513 provided to form at the position corresponding to the hood protrusion 523 and protrude toward the cover hood 520.

The cover body 510 may include a second electrical component hole 540 provided to allow the conducting wire 140 to pass therethrough.

A second hole protrusion 541 protruding toward the outside of the cover body 510 may be provided on an inner circumference of the second electrical component hole 540. Because an area of an inner circumferential surface of the second electrical component hole 540 increases due to the second hole protrusion 541, the conducting wire 140 may be prevented from being damaged by rubbing against the inner circumferential surface of the second electrical component hole 540.

Because the second electrical component cover may include a plastic material, the second electrical component cover may not have a necessary strength. Accordingly, the second electrical component cover 500 may have a configuration to complement this.

The cover body 510 may include a body rib 514 provided to extend along a side surface from a bottom surface. The body rib 514 may have a height up to an upper surface of the cover body 510. As the body rib 514 is formed, a strength of the cover body 510 may be strengthened. The body rib 514 may be formed on an inner side of the cover body 510.

The cover body 510 may include a body entrance recess 515 on an outer surface thereof. As the body entrance recess 515 is formed, the strength of the cover body 510 may be strengthened. The body entrance recess 515 may be provided in front of the cover body 510. More specifically, the body entrance recess 515 may be provided below the body protrusion 513.

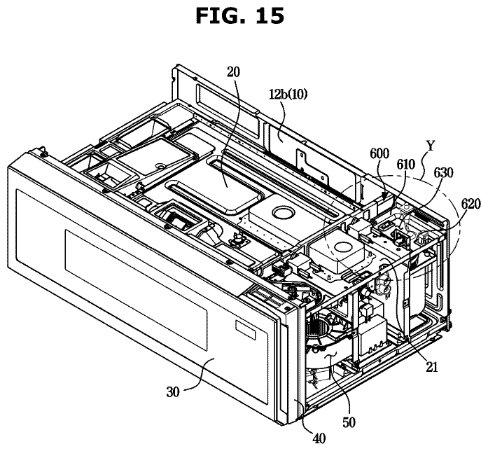

FIG. 15 is a perspective view illustrating that the outer housing cover 11 is removed from the cooking apparatus 1 of FIG. 1.

As illustrated in FIG. 15, a power connector 600 may be provided at the rear of the cooking apparatus 1. When water enters the power connector 600 side, the water may permeate into the electrical component 100 that may be positioned below the power connector 600. Because the electrical component 100 may break down when water enters therein, a structure is needed to prevent this. A description of this structure is given later.

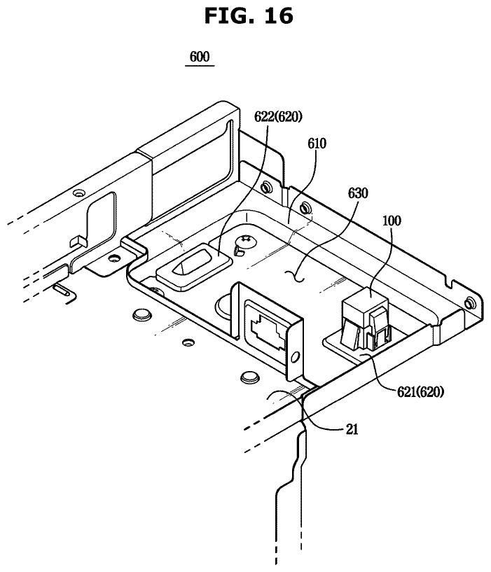

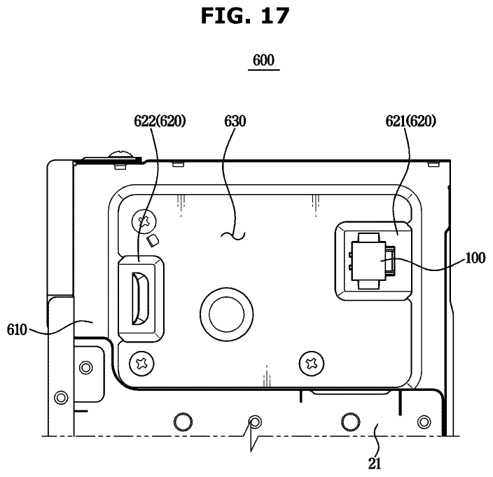

FIG. 16 is an enlarged perspective view of a power connector in a part Y indicated in the cooking apparatus 1 of FIG. 15. FIG. 17 is a top view of the power connector 600 of FIG. 16, which is viewed from above.

As illustrated in FIGS. 16 and 17, the power connector 600 may include a water receiving plate 610 provided at the rear of the upper plate 21 of the inner housing. The water receiving plate 610 may protect the electrical component 100 positioned on a lower side thereof from the outside.

The conducting wire 140 connected to the electrical component 100 may be connected to the lower side of the water receiving plate 610. A passing hole to allow the conducting wire 140 to pass through may be formed on the water receiving plate 610. In order to prevent water from entering the passing hole, the water receiving plate 610 may include a water receiving protrusion 620 provided at a position where the conducting wire 140 passes.

A plurality of the water receiving protrusions 620 may be formed. The water receiving protrusions 620 may be referred to as a first water receiving protrusion 621 and a second water receiving protrusions 622, respectively.

The water receiving plate 610 may include a water receiving recess 630 provided to be recessed downward. Because when water enters the water receiving plate 610, the water is collected in the water receiving recess 630, water may not enter the electrical component 100 positioned on the lower side of the water receiving plate 610.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

1. A cooking apparatus comprising:
an outer housing;
an inner housing inside the outer housing and including a cooking chamber;
a door in front of the inner housing to open and close the cooking chamber;
a vent fan including a discharge port, and positioned in a separation space between the outer housing and the inner housing, wherein the vent fan is configured to draw air into the cooking apparatus and discharge the air through the discharge port so that the air flows from the discharge port along a route inside the cooking apparatus;
an electrical component positioned on the route; and
an electrical component cover including an electrical component cover body surrounding the electrical component to protect the electrical component from the air flowing along the route.

2. The cooking apparatus according to claim 1, wherein
the electrical component cover body includes:
a blocking wall between the electrical component and the discharge port of the vent fan to prevent air discharged from the discharge port of the vent fan toward the electrical component from directly coming into contact with the electrical component, and
a plurality of walls extending from the blocking wall to cover a periphery of the electrical component, and
the plurality of walls include an upper wall extending upward at a predetermined angle to guide the air flowing along the route.

3. The cooking apparatus according to claim 1, further comprising:
a vent plate between the vent fan and the electrical component to reduce a flow of air to the electrical component and to partition a space in which the electrical component is located and a space in which the vent fan is located.

4. The cooking apparatus according to claim 3, wherein
the electrical component cover is spaced apart from the discharge port of the vent fan to reduce contact of the air flowing along the route with the electrical component, and
the vent plate includes:
a plate opening positioned to correspond to the discharge port of the vent fan, and
a plate guide bent and extending from an edge of the plate opening to guide air discharged from the discharge port of the vent fan.

5. The cooking apparatus according to claim 4, wherein
the vent plate includes a base plate on one side of which the plate opening is formed, and a plate wall bent and extending from an other side of the base plate spaced apart from the plate opening, and
the electrical component cover is coupled to the plate wall to reduce contact of air discharged from the discharge port with the electrical component.

6. The cooking apparatus according to claim 4, wherein
the vent fan includes a first vent fan and a second vent fan positioned at a rear of the first vent fan,
the plate opening includes a first plate opening formed to correspond to the first vent fan and a second plate opening formed to correspond to the second vent fan, and
the electrical component cover is between the first plate opening and the second plate opening to reduce direct contact with air discharged from the first vent fan and the second vent fan.

7. The cooking apparatus according to claim 5, wherein
the plate wall includes a plate recess recessed in a direction toward the inner housing at a position where the electrical component is provided.

8. The cooking apparatus according to claim 5, wherein
the plate wall includes a plate fitting protrusion provided by a portion of the plate wall being bent and extending, and
the electrical component cover includes, in order to couple the electrical component cover to the plate wall, a cover flange bent and extending from one side of the electrical component cover body facing the plate wall and having an end accommodated in the plate fitting protrusion.

9. The cooking apparatus according to claim 8, wherein
the plate fitting protrusion includes:
a fitting support part provided by a portion of the plate wall bent and extending, and protruding in a direction in which the electrical component cover is coupled, and
a fitting separation prevention part bent from an end of the fitting support part and extending at a determined angle in a direction in which the cover flange is inserted so that the cover flange is smoothly fitted into the plate fitting protrusion.

10. The cooking apparatus according to claim 5, wherein
the plate wall includes a locking opening, and
the electrical component cover includes, in order to couple the electrical component cover to the plate wall, a cover protrusion formed at a position corresponding to the locking opening to be accommodated in the locking opening.

11. The cooking apparatus according to claim 10, wherein
the cover protrusion includes:
a locking support part provided to extend in a direction toward the plate wall to be accommodated in the locking opening,
a locking separation prevention part provided to be bent and extend from an end of the locking support part to prevent the cover protrusion from being separated from the locking opening when the cover protrusion is accommodated in the locking opening, and
a locking insertion part provided to be bent from an end of the locking separation prevention part and extend toward a base plate to smoothly accommodate a cover locking part in the locking opening.

12. The cooking apparatus according to claim 5, wherein
the plate wall is positioned adjacent to one side of the inner housing,
the plate wall includes a plate cutout piece bent and extending at a predetermined angle in a direction opposite to a direction toward the inner housing,
the electrical component cover includes a cover cutout piece at a position corresponding to the plate cutout piece, and
the cooking apparatus further includes a coupling member provided to penetrate and be coupled to the plate cutout piece and the cover cutout piece, so that the coupling member is prevented from penetrating the inner housing.

13. The cooking apparatus according to claim 12, wherein
the electrical component cover includes a coupling guide adjacent to a position where the coupling member is to be coupled to guide coupling of the coupling member and extending beyond a height of the plate cutout piece.

14. The cooking apparatus according to claim 5, wherein
the outer housing includes:
a circulation air intake port on a lower side of the outer housing to allow air to be introduced into the outer housing, and
a circulation air discharge port on an upper side of the outer housing to allow the air introduced from the circulation air intake port to be discharged,
the circulation air discharge port includes:
a first circulation air discharge port adjacent to the vent fan, and
a second circulation air discharge port between the first circulation air discharge port and a control panel,
the route includes:
a first circulation flow path along which air discharged from the discharge port of the vent fan is discharged to the first circulation air discharge port, and
a second circulation flow path along which air discharged from the discharge port of the vent fan is discharged to the second circulation air discharge port, and
the electrical component is positioned on the first circulation flow path, and the electrical component cover covers the electrical component to reduce contact of air flowing along the first circulation flow path with the electrical component.

15. The cooking apparatus according to claim 14, wherein
the electrical component is a first electrical component and the electrical component cover is a first electrical component cover,
the cooking apparatus further includes a second electrical component positioned on the second circulation flow path and a second electrical component cover surrounding the second electrical component to reduce contact of air flowing along the second circulation flow path with the second electrical component,
the second electrical component cover includes a cover body and a cover hood provided to open and close the cover body,
the cover hood includes a hood protrusion provided to protrude toward the cover body when the cover hood comes into contact with the cover body so that separation of the cover hood from the cover body becomes difficult in a state in which the cover hood is in contact with the cover body, and
the cover body includes a body protrusion provided to form at a position corresponding to the hood protrusion and protrude toward the cover hood in order to couple the cover hood to the cover body.
